(19) United States
(12) Patent Application Publication
(10) Pub. No.: US 2005/0114278 A1
(43) Pub. Date: May 26, 2005

(54) System and methods for incrementally augmenting a classifier

(76) Inventors: Mahesh Saptharishi, Medford, MA (US); John B. Hampshire II, Poughkeepsie, NY (US)

Correspondence Address: STOEL RIVES LLP, 900 SW FIFTH AVENUE, SUITE 2600, PORTLAND, OR, 97204, US

(21) Appl. No.: 10/928,709

(22) Filed: Aug. 27, 2004

Related U.S. Application Data
(60) Provisional application No. 60/499,123, filed on Aug. 29, 2003.

(51) Int. Cl. G06F 15/18; G06N 5/02; G06F 17/00

(52) U.S. Cl. 706/20; 706/46

(57) ABSTRACT

A method augments an original discriminator in a classifier. The original discriminator has a set of input connections to receive feature data derived from an input pattern. The original discriminator generates in response to an input pattern a set of original discriminator outputs. The method connects an additional discriminator to the original discriminator. The additional discriminator has a set of parameters. The additional discriminator also has a first set of input connections configured to receive feature data derived from an input pattern and a second set of input connections to receive some or all of the set of original discriminator outputs. The additional discriminator generates a set of outputs in response to said some or all of the set of original discriminator outputs and in response to the feature data according to the set of parameters. The method applies a set of training input patterns to both the original and additional discriminator in parallel. Responsive to the training input patterns, the method adjusts the values of the parameters in the set of parameters using an RDL technique, whereby the combination of the original discriminator and the additional discriminator provides greater classification performance than the original discriminator alone.

### RELATED APPLICATION

This application claims priority under 35 U.S.C. § 119 to U.S. Provisional Application No. 60/499,123, entitled “Method and Apparatus for Building Statistically Efficient Pattern Classification and Value Assessment Systems Incrementally,” filed Aug. 29, 2003, and published as Publication No. 2003/0088532, which is incorporated by reference herein in its entirety.

### TECHNICAL FIELD

This disclosure relates generally to networks, such as neural networks, utilized to perform classification tasks and more particularly to construction and training of such networks.

### BACKGROUND

Pattern recognition and/or classification is useful in a wide variety of applications, such as image processing, optical character recognition, remote sensing imagery interpretation, medical diagnosis/decision support, digital telecommunications, and the like. Such pattern classification is typically accomplished using a trainable network, such as a neural network, which can “learn” the concepts necessary to perform pattern classification tasks through a series of training exercises. Such networks can be trained by inputting to them (a) input patterns as learning examples of the concepts of interest and (b) actual classifications respectively associated with the examples. The classification network learns the key characteristics of the concepts that give rise to a proper classification for the concept.

Such a network may be referred to as a classifier. A typical classifier comprises a discriminator, which can be described mathematically by a set of discriminant functions, which are typically differentiable functions of its parameters. If we assume that there are K of these functions, corresponding to C classes that an input feature vector can represent, these K functions are collectively known as the discriminator. Thus, the discriminator has a K-dimensional output. Discriminant functions are typically differentiable functions of their parameters. The classifier's output is simply the class label corresponding to the largest discriminator output. In the special case of K=2, the discriminator may have only one output in lieu of two, that output representing one class when it exceeds its mid-range value and the other class when it falls below its midrange value. A classifier is learnable when it learns an input-to-output mapping by adjusting the internal parameters of the discriminator functions via a search aimed at optimizing an objective function, which is a metric that evaluates how well the classifier's evolving mapping from feature vector (input) space to classification (output) space reflects the empirical relationship between the input patterns of the training sample and their externally-determined class membership. When the objective function is differentiable, the classifier is said to be differentiable.

Neural networks are well-known trainable networks. See, e.g., Simon Haykin, Neural Networks: A Comprehensive Foundation, Prentice Hall (2d. ed. 1999). Typically, a neural network comprises a number of layers connected to each other via synapses. Each layer accepts inputs from either the external world or a previous layer and computes outputs formed by multiplying its inputs by respective synaptic weights and then passing the weighted sum of the inputs through an activation function. Using training samples and their corresponding desired responses, a neural network performs learning by adjusting its synaptic weight parameters so that its outputs match the desired responses. In this way, a neural network classifier forms its own mathematical model of the concepts to be classified, based on the key characteristics it has learned. With this model, the network can thereafter recognize other examples of the concept when they are encountered.

The above-referenced U.S. Patent Application No. 60/499,123 discloses learning techniques, termed “risk differential learning” (RDL), for training a classifier. RDL employs a particular type of objective function that is generally the sum of one or more risk/benefit/classification figure of merit (RBCFM) functions, each of which is a synthetic, montonically non-decreasing, anti-symmetric/asymmetric, piecewise-differentiable function of a risk differential, which is the difference between selected outputs of the discriminator. RDL can guarantee maximum correctness and minimum complexity in certain cases. The above-referenced patent application also discloses the use of RDL in value assessment problems, which is a special class of classification problems in which the putative values (e.g., profit or loss potentials) of decisions are evaluated.

### SUMMARY

According to one embodiment, a method augments an original discriminator in a classifier. The original discriminator has a set of input connections to receive feature data derived from an input pattern. The original discriminator generates in response to an input pattern a set of original discriminator outputs. The method connects an additional discriminator to the original discriminator. The additional discriminator has a set of parameters. The additional discriminator also has a first set of input connections configured to receive feature data derived from an input pattern and a second set of input connections to receive some or all of the set of original discriminator outputs. The additional discriminator generates a set of outputs in response to said some or all of the set of original discriminator outputs and in response to the feature data according to the set of parameters. The method applies a set of training input patterns to both the original and additional discriminator in parallel. Responsive to the training input patterns, the method adjusts the values of the parameters in the set of parameters using an RDL technique, whereby the combination of the original discriminator and the additional discriminator provides greater classification performance than the original discriminator alone.

According to yet another embodiment, a method building a multi-layered classifier capable of accepting an input pattern and generating an output that indicates a class to which the input pattern is likely associated out of a set of possible classes. The classifier is built by successively adding new layers to the system so as to result in the classifier comprising an ordered set of N interconnected layers, wherein N≧2, Each layer is characterized by a set of parameters. The method adjusts the parameters of a first layer using a first set of input patterns, the adjusting step being based a first RDL objective function. The method holds the parameters of the first layer constant after the step of adjusting the parameters of the first layer. The method adds a second layer to the classification system. The method adjusts the parameters of the second layer using a second set of input patterns, the adjusting step being based on a second RDL objective function.

According to another embodiment, a system comprises a data source, a classifier, and an RDL module. The data source generates input patterns and respective actual classifications of the input patterns. The classifier comprises a discriminator comprising N layers interconnected in an ordered arrangement from layer 1 to layer N. Each layer has a set of inputs connected to the data source via a parameterized model. Each layer generates a set of outputs that are related to likelihoods that an input pattern belongs to a respective class in a set of possible classes. Each layer but layer 1 has a set of inputs connected to the outputs of a previous layer. The RDL module has inputs connected to the outputs of layer 1 of the discriminator, wherein the data source, the discriminator, and the RDL module cooperate to successively train the i-th layer of the discriminator while holding constant all parameters of layers 1 though i−1 and without activating any layer i+1 through N, as i ranges from 1 to N.

Details concerning the construction and operation of particular embodiments are set forth in the following sections.

### BRIEF DESCRIPTION OF THE DRAWINGS

FIG. 1 is block diagram of a system according to one embodiment.

FIG. 2 is diagram of a single layer of a discriminator in the system of FIG. 1, according to one embodiment.

FIGS. 3-5 are diagrams of two-layer discriminators in the system of FIG. 1, according to one embodiment.

FIG. 6 is a flowchart of a method according to one embodiment.

FIG. 7 is diagram of a discriminator after N increments according to one embodiment.

FIG. 8 is diagram of a use of a discriminator according to one embodiment.

FIG. 9 is diagram of another use of a discriminator according to one embodiment.

### DETAILED DESCRIPTION OF AN EMBODIMENT

With reference to the above-listed drawings, this section describes particular embodiments and their detailed construction and operation. As one skilled in the art will appreciate, certain embodiments may be capable of achieving certain advantages over the known prior art, including some or all of the following: (1) the desirable performance characteristics of RDL, namely statistical efficiency in that the scheme can in certain cases guarantee maximal correctness and/or maximal value to the user in a manner that is consistent with, and regulated by, the incremental procedure used to build them; (2) the ability to handle complex learning tasks by adding complexity until a desired performance is reached; (3) the ability to handle the addition of new learning data and the addition of new classes to the set of possible classes; (4) the ability to take advantage of learning that has already occurred; (5) maximal correctness and/or maximal value consistent with the incremental learning approach; (6) simplification of the task of building complex, non-linear pattem classification systems to a building task that comprises a simple, modular sequence of building increments; (7) in real-time post-learning classification can be conducted incrementally with the number of operative increments determined by the real-time constraints placed on the system; in fact, each increment maximizes the increase in correctness of the resulting classification of the resulting decision assessment; (8) the combination of RDL and incremental learning can guarantee that the current model increment will yield maximal classification correctness and/or assessment value; indeed, any incremental learning procedure using the same model primitive but not using RDL will in most cases yield inferior classification correctness and/or assessment value; and (9) incremental RDL is very useful in building classifiers that must function with a limited computational budget, as incremental RDL can in certain cases guarantee a minimal complexity classifier with the maximum attainable correctness with the given data and complexity level, whereas neither RDL alone nor incremental complexity addition without RDL has that advantage. These and other advantages of various embodiments will be apparent upon reading the following.

A. The Overall Classification Learning System

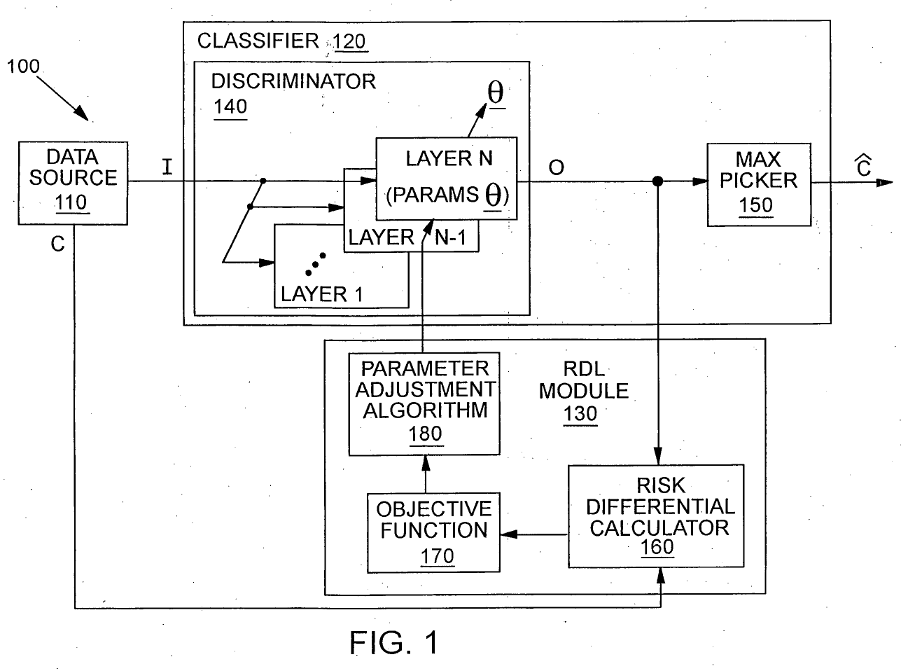

FIG. 1 is a block diagram of a system 100 according to one embodiment. The system 100 comprises a data source 110, a classifier 120, and an RDL module 130. The data source generates an input pattern I and its actual classification C from a finite set of possible classes. A discriminator 140 within the classifier 120 accepts the input pattern I and generates a set of outputs O. The structure of the classifier 120 is explained in detail below. The number of outputs in the set of outputs O is typically the same as the number of possible classes, and each individual output value is a quantity related to the likelihood that the input pattern I belongs to one of the possible classes. A maximum picker 150 chooses from among the set of outputs O the one having the highest value. The class corresponding to that highest value output is an estimate Ĉ of the classification of the input pattern L The RDL module 130 trains the classifier 120 (more specifically, the discriminator 140) by augmenting its structure with additional layers incrementally, according to techniques such as the ones described in detail below.

The discriminator 140 embodies an arbitrarily parameterized classification model of the concepts that need to be learned. The discriminator 140 is preferably a neural network that defines such a model but it may be any type of self-learning model that can be taught or trained to perform a classification or value assessment task represented by the mathematical mappings defined by the model. As used herein, the term “discriminator” includes any system, network, or model that constitutes a parameterized set of mathematical mappings from a input pattern to a set of outputs, each output corresponding to a unique classification of the input pattern or a value assessment of a unique decision which may be made in response to the input pattern. Thus, a discriminator is generally a multiple-input, multiple-output system. A discriminator, such as the particular discriminator 140 illustrated in FIG. 1 and described in detail by way of example, can be implemented in various forms. For example, it can be simulated in software running on a general-purpose computer or on a special-purpose computer, such as a digital signal-processing (DSP) chip; it can be implemented in a field-programmable gate array (FPGA) or an application specific integrated circuit (ASIC); it can also be implemented in a hybrid system, comprising a general-purpose computer with associated software, plus peripheral hardware/software running on a DSP, FPGA, ASIC, or some combination thereof.

The discriminator 140 comprises a number of ordered layers. New layers are added incrementally to improve the performance of the classifier 120. Although each layer need not have identical connective structure, that is typically the case. Each layer is characterized by its own set of parameters θ, whose values are adjusted by the learning technique described below. Furthermore, the layers are interconnected such that the outputs of each non-final layer are connected to inputs of one or more subsequent layers. Preferably, the layers are connected serially, i.e., the outputs of layer 1 are input to layer 2, the outputs of layer 2 are input to layer 3, etc. The input pattern I is fed to all layers, but the output of the discriminator 140 is taken from the final layer only. Each additional layer utilizes the outputs of the previous layer(s) and builds on that information to provide more discriminating classification power. Moreover, only the additional (topmost) layer undergoes learning; previous layers are fixed to retain the knowledge they have already learned. This is in contrast to tabula rasa re-training of the entire augmented system from scratch. The layers are preferably neural network layers, in which case the parameters θ are synaptic weights; however, the structure of the layers is not so constrained. As used herein, the term “layer” means any layer, stage, increment, or the like of a multi-layer or cascade system, network, transform, or the like.

The overall classification operation is culminated by the operation of the maximum picker 150, which selects as the estimated classification the class corresponding to the largest individual output of the discriminator 140. To analogize to error correction decoding, the set of outputs O are like soft decoding decisions, whereas the estimated classification Ĉ is a hard decoding decision.

The discriminator 140 is trained or taught by presenting to it a set of learning examples of the concepts of interest, each example preferably being in the form of an input pattern I, preferably expressed mathematically by an ordered set of numbers. During this learning phase, input patterns I are sequentially presented to the classification system 120. The input patterns I are obtained from a data source 110, which may be a data acquisition and/or storage device. For example, the input patterns I could be a series of labeled images from a digital camera; they could be a series of labeled medical images from an ultrasound, computer tomography scanner, or magnetic resonance imager; they could be a set of telemetry from a spacecraft; they could be ticker data from a securities or commodities market obtained via the Internet. Any data acquisition and/or storage system that can serve a sequence of labeled examples can provide the input patterns I and corresponding class/value labels C required for learning. The number of input patterns in the training set may vary depending upon the choice of classifier model to be used for learning, and upon the desired degree of classification correctness achievable by the model. In general, the larger the number of the learning examples, i.e., the more extensive the training, the greater the classification correctness that will be achievable by the classifier 120.

Each input pattern I comprises an ordered set of features that represent one instance of a concept the system 100 is to learn to classify. Each input pattern I is preferably expressed mathematically as a vector, the components of which are features: I=[f₁ f₂ . . . f_{M}]^{T}. For example, in the case where the data source 110 is a camera generating images, the data source 110 may contain a feature extractor (not shown), which extracts feature data relating to an imaged object. Illustrative features of an imaged object are its height, width, and coloration. The input pattern I may be augmented with an additional bias term, as described below. Preferably, a feature element of an input pattern I can be mapped to some metric space such that feature values close to one another are more similar than those farther apart. Features are typically associated with the same time instance of an object, but that need not be the case. For example, an object's speed can be a feature derived from the same conceptual object over some period of time. A speed feature could be helpful to distinguish between a humming bird and a pigeon, for example.

The classifier 120 responds to the input patterns I to train itself by an RDL technique, as implemented by the RDL module 130. Each individual input pattern I has associated with it a desired output classification/value assessment C. In response to each input pattern I, the discriminator 140 and the maximum picker 140 generate discriminator outputs O and an estimate output classification Ĉ of the input pattern I, respectively. The discriminator 140 output corresponding to the desired output C is compared to the maximum remaining discriminator output to calculate a risk differential

$$δ = {o}_{C} - {max}_{i \neq C} \{ {o}_{i} \}$$

where O=[o₁ o₂ . . . o_{K}]^{T} for a K-class classification problem. The risk differential is calculated by the risk differential calculator 160. The resulting risk differential δ is utilized as an argument in an RDL objective function 170, which is a measure of “goodness” for the comparison of the estimate classification Ĉ to the true classification C. The result of this comparison is, in turn, used to govern, via a numerical optimization algorithm 180, adjustment of the parameters of the discriminator 140. The precise nature of the numerical optimization algorithm 180 is unspecified, so long as the RDL objective function 170 is used to govern the optimization. Thus, a differential comparison effects a numerical optimization or adjustment of the RDL objective function 170 itself, which results in the model parameter adjustment, which, in turn, ensures that the classifier 120 generates actual classification (or valuation) outputs that match the desired ones with a high level of goodness.

The learning procedure repeats the sequence of events just described for each input pattern I in the set of all patterns to be learned (i.e., a “learning sample”). One pass over the learning sample is called an “epoch.” Generally, the RDL learning procedure involves many epochs, that is, many repetitions over the entire learning sample. The ensemble of all epochs for which the connective architecture of the discriminator 140 remains unchanged is called an “increment”. A model incrementor (not shown) embodies a decision mechanism used to decide whether or not to augment the discriminator 140 following the completion of an epoch. Augmentation involves expanding the connective architecture of the discriminator 140. The specifics of the decision mechanism and the augmentation of the discriminator 140 are described in detail below. In brief, there are four typical reasons to initiate a new increment: (1) The complexity of the discriminator 140 does not yield sufficiently high classification correctness or value assessment for the task; (2) New data (i.e., new input patterns I) become available for learning, thus increasing the size (and, perhaps, the statistical scope) of the overall learning sample; (3) The learning task is expanded to include new classifications (both estimated and desired) not previously considered by the classifier 120; and (4) The elements of the input patterns I are expanded to include a superset of the features in the current set of input patterns L

After the discriminator 140 has undergone its learning phase, encompassing all epochs for each of its increments, the classifier 120 can respond to new input patterns which it has not before seen, to properly classify them, to assess the profit and loss potential of decisions which may be made in response to them, or to perform other tasks based on classification

B. Incremental Augmentation Process

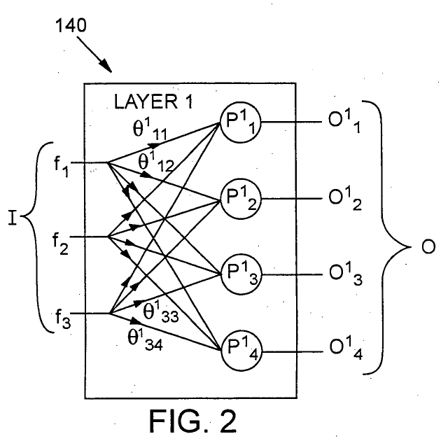

FIGS. 2-5 depict the inner structure of the discriminator 140 taking the form of a neural network. In FIG. 2 a single-layer neural network discriminator 140 is shown. The inputs to the discriminator 140 are features f₁, f₂, and f₃, all derived from an input pattern I. These inputs are connected along synapses to four model primitives P¹₁, P¹₂, P¹₃, and P¹₄. Associated with each synapse is a weight parameter, the first and last two of which are labeled in the figure (θ¹₁₁, θ¹₁₂, θ¹₃₃, and θ¹₃₄—the first subscript referring to the input feature and the second subscript referring to the primitive or output). The superscripts indicate the layer, in this case, layer 1. Collectively, all of the parameters in layer 1 are referred to as simply θ¹. The total number of parameters in layer 1, assuming that the input vector is not augmented, is |θ¹|=|I|·|O¹|, where the number of parameters in any vector z is denoted by |z| (also known as the “cardinality” of z). If the arbitrary vector z is augmented with a single additional bias term (not shown), it is denoted by z′. Consequently, if the input feature vector is augmented, the total number of parameters becomes |θ¹|=|I′|·|O¹|,|I′|=|I|+1.

Mathematically, each primitive is a function of the input pattern I, preferably a non-linear function of the input pattern I. The functional form of the primitive is such that it generates a partially-closed or fully-closed region on the domain of the input pattern I. By creating such a region in the context of the regions corresponding to the other pattern or decision classes, the overall neural network discriminator divides the domain of input patterns I into a set of at least C regions for a C-class pattern recognition or decision value assessment task. Each of these regions corresponds to the set of all input patterns I therein, which are to be associated with one of the K possible pattern or decision classes. The specific functional form of the model primitives can be quite varied. Referring to FIG. 2, one illustrative form of the model primitives typical of neural networks is

$${o}_{j}^{1} = φ ( {\sum }_{i = 1}^{3} {θ}_{ij}^{1} {f}_{i} ) ,$$

j=1,2,3,4 where φ is an activation function. Different functions generate different types of partially-closed or fully-closed regions on the domain of the input pattern I. Consequently, a particular classification task might benefit from one specific or multiple model primitives. In a preferred implementation, described below, there are restrictions on the functional form of the model primitives that guarantee maximal correctness or assessed value under certain conditions.

As described above, there are four typical scenarios in which the basic connective architecture of the neural network classifier 120 described in the preceding section might be augmented incrementally. A later section describes each of these cases in detail and specifies a decision mechanism used to initiate the increments. This section describes how the connective architecture of the basic neural network discriminator 140 is augmented through successive increments.

FIG. 2 illustrates the simplest neural network model (i.e., single layer) that could be used to learn a four-class pattern recognition task. The hypothetical task involves classifying digital images (input patterns I) of objects into one of four classes. Note that the number of output primitives is four in this example for illustrative purposes. In the general case, the number can be any number greater than zero, depending on the classification/valuation task specifics. For example, the four outputs could correspond to four classes—car, truck, person, and surfboard—in a classification scheme. This is the discriminator 140 used in the first increment or layer of learning of the system 100.

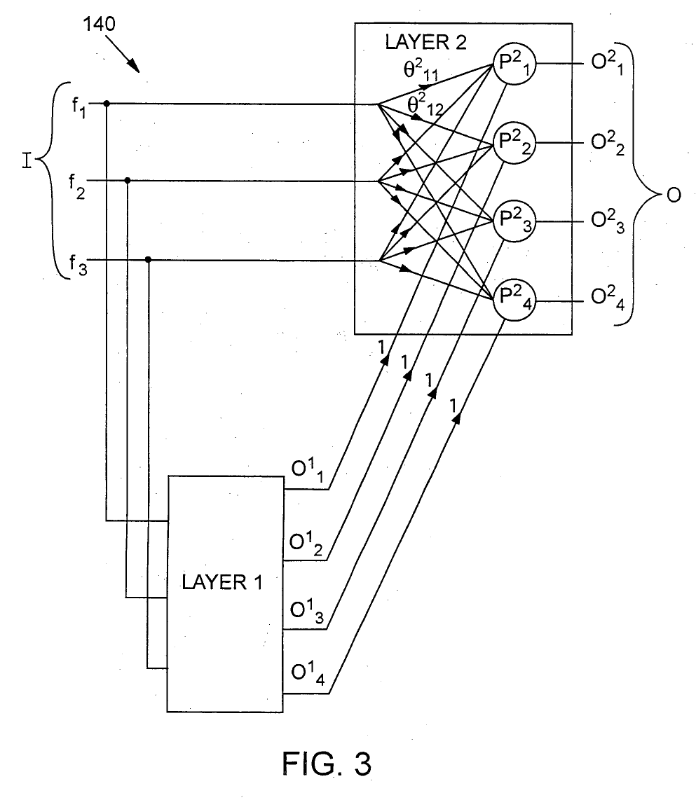

Referring to FIG. 1 in the specific context of FIG. 2, when the decision to “increment” (i.e., augment the connective architecture of) the neural network discriminator 140 by connecting an additional layer to the original layer is affirmative, the resulting incremented neural network discriminator 140 is illustrated in one of FIGS. 3-5. In those figures, the additional layer (layer 2) is formed by
(1) “fixing” (i.e., holding constant) all of the learned parameters θ¹ of layer 1 so that they are not altered during follow-on learning epochs;
(2) connecting each of the outputs of the layer 1 primitives P¹₁-P¹₄ of to an input of its corresponding layer 2 primitive P²₁-P²₄ with fixed, unit value weights that are not altered during follow-on learning epochs; and
(3) connecting the potentially augmented input pattern I (which itself may be potentially augmented) to each of the four new layer 2 primitives P²₁-P²₄ and initializing these connections to parameter values equal to zero; collectively, the parameters of layer 2 are denoted θ² (layer index is superscript for notational consistency), the values of which are altered during follow-on learning epochs within the same increment by applying an RDL learning process to those parameters.

Because the inter-layer weights are set at unity and the new layer's input weighted parameters are initialized to zero, the augmented discriminator 140 initially behaves just as the unaugmented discriminator (FIG. 2) did. However, subsequent learning of the parameters θ² can provide greater classification performance by the combination of both layers than achievable by the first layer alone. For example, training of layer 1 may result in acceptable classification between cars and trucks, on one hand, as opposed to persons and surfboards, on the other hand. Layer 1 by itself, however, may be incapable of acceptably distinguishing cars from trucks and persons from surfboards. One or more additional layers can provide that finer level of discrimination.

Referring to the fixing step (1) above, as the network increments and initializes its second layer, it fixes the parameters of the first increment θ¹ so that their values remain permanently set to those immediately prior to the spawning of the second increment. Thus, θ¹ never changes following completion of the first increment. The only parameters that can be learned during the second increment are those newly spawned (θ² in FIG. 3). In the more general case involving N+1 increments, the parameters of the Nth increment are fixed, as described above, at the completion of the Nth increment; only the parameters of the (N+1)th increment are learnable.

Referring to the connecting step (2) above and FIG. 3, each of the outputs from the first layer is connected to its counterpart primitive in layer 2 and no other. Permanently fixed unit values are utilized as the weights of those connections. Thus, for example, an expression for the third primitive in layer 2 might take the form

$${o}_{3}^{2} = φ ( {\sum }_{i = 1}^{3} {θ}_{i3}^{2} {f}_{i} + {o}_{3}^{1} ) .$$

Referring to the connecting step (3) above and FIG. 3, each of the feature vector elements f₁, f₂, and f₃ is connected to both layers, and the size of the parameter vector θ² is identical to its counterpart θ¹ in the previous increment, and all the vector's elements are initialized to zero:

$$\begin{matrix}\vert {\underline{θ}}^{2} \vert = \vert {\underline{θ}}^{1} \vert \\ {\underline{θ}}^{2} = [ \begin{matrix}0 \\ ⋮ \\ 0\end{matrix} ]\end{matrix}$$

These equations can be generalized to an arbitrary Nth increment as follows:

$$\begin{matrix}\vert {\underline{θ}}^{N} \vert = \vert {\underline{θ}}^{N - 1} \vert \\ {\underline{θ}}^{N} = [ \begin{matrix}0 \\ ⋮ \\ 0\end{matrix} ]\end{matrix}$$

Note from these equations that the total number of parameters in the Nth increment equals the total of the previous increments (up to N−1) plus the number of new parameters with the addition of the Nth increment.

Following this initialization of the Nth increment, the parameters θ^{N} are modified via a learning procedure, a preferred implementation of which employs specific neural network primitives for the discriminator 140 and a simple variant of a well-known numerical optimization method as the parameter adjustment algorithm 180. This preferred implementation, used in combination with the RDL module 130, enables the system 100 to make the certain correctness guarantees. Although the discriminator 140 may employ a very broad range of primitives, the model primitive is preferably (1) a function of an affine transformation of the vector dot product of the input pattern (feature vector) and the learnable function parameters, wherein the input pattern vector might be augmented, for example, by a single element of unit value, which would constitute a bias term for the affine transformation; and (2) a differentiable, function with finite bounds, typically between zero and positive one or negative one and positive one, that generates half-open hyperplanar or potentially closed hyperbolic/hyperelipsoidal contours of constant value over the domain of the input pattern. Any affine transformation of the hyperbolic tangent (tanh) function constitutes an example of a model primitive that satisfies these requirements.

The preferred numerical optimization method is gradient ascent with momentum and weight (i.e., learned parameter) decay. This method is a variant of back-propagation, a method commonly used in neural network learning. Back-propagation is gradient descent with regularization in the form of momentum and weight decay. This variant allows the numerical optimization algorithm 180 to be paired with an RDL objective function 170. Rather than minimizing an error function, the variant maximizes the RDL objective function 170. Minimizing the negative of the RDL objective function 170 by back-propagation is equivalent to gradient ascent maximization of the RDL objective function 170. An alternative optimization method is conjugate gradient ascent, which can converge more quickly in cases where the discriminator 140 model is almost convex or quasiconvex. The inventors have discovered that conjugate gradient ascent is preferred when the number of classes is three or less, and that gradient ascent with momentum and weight decay is preferred when the number of classes is four or more. Software implementations of the optimization algorithm are presently preferred, but in a hardware implementation, optimization by the method of finite differences may be preferable as an approximation.

Next is described a decision mechanism used to initiate a new increment for each of the four typical scenarios that might require a discriminator increment. When the discriminator 140 is being generated, the RDL module 130 decides at every epoch whether or not it should add the next increment to the discriminator 140 and continue learning. The RDL module 130 is optionally provided the following set of operating parameters before it is initialized: (1) a limit to the number of increments the learning algorithm can add; and (2) a maximum number of epochs that the learning algorithm can devote to each increment. If the above two operating parameters are not specified, values of infinity can be assumed for both parameters. Within the operating bounds specified by the parameters, the RDL module 130 preferably autonomously decides when to add the next increment. Any one or more of the following conditions are situations in which a new increment should be added. First, the parameter adjustment algorithm 180 reaches a local optimum. Second, the RDL module 130 devotes the maximum number of epochs that it can devote to the current increment. When either of the above conditions is encountered, a new increment is added as long as the limit on the number of increments has not been reached.

Moreover, new data can be accommodated incrementally. When new data input patterns become available, augmenting the learning sample, it is often easier to increment the model than it is to generate a new model from scratch (i.e., tabula rasa). Referring to FIG. 3, the old model (layer 1) becomes the preceding increment of the new model (layers 1 and 2). All input patterns I (i.e., the union of the original learning sample and the new data) are then learned with the new increment, which relies heavily on the previous increment to perform the classification task. The learnable parameters θ² of the new increment serve to encode the residual information necessary to learn the new data in the context of the previous increment.

Similarly, new concept classes can be accommodated incrementally, as illustrated in FIG. 4. When one or more new classes are added to the set of possible classes, again it is often easier to increment the model than it is to generate a new model tabula rasa. Referring to FIG. 4, the original model (layer 1) becomes the preceding increment of the new model (layers 1 and 2). All input patterns I (i.e., the union of the original learning sample and the new data) are then preferably learned with the new increment, which relies heavily on the previous increment to perform the classification task for the original pattern classes. The learnable parameters θ² of the new increment serve to encode the residual information necessary to learn the new pattern classes (represented by primitive P₅²) in the context of the previous increment. The mathematical details of this incrementation are as described above with one alteration. More specifically, the larger number of concept classes in the new increment, corresponding to the addition of primitive p²₅ in the figure, means that |θ²|=|I| |O²|=|I|(|O¹|−1). These modifications generalize to the N-increment case with any arbitrary number of additional classes in the Nth increment.

In operation, the first four primitives of layer 2, which correspond to outputs generated by the original layer 1, preferably implement the following equation:

$${o}_{j}^{2} = φ ( {\sum }_{i = 1}^{3} {θ}_{ij}^{2} {f}_{i} + {o}_{j}^{1} ) ,$$

j=1,2,3,4. The fifth parameter, which has no analog in the original layer 1, has no connection to layer 1 and therefore preferably implements an equation of the form

$${o}_{5}^{2} = φ ( {\sum }_{i = 1}^{3} {θ}_{i5}^{2} {f}_{i} ) .$$

As a final example, new features in the input pattern can be accommodated incrementally, as shown in FIG. 5. When one or more new features are added to the existing set of input pattern features, again it is often easier to increment the model than it is to generate a new model tabula rasa. For the case in which the additional features are available only for new learning examples, this scenario encompasses an earlier use case as well. Referring to FIG. 5, the original discriminator (layer 1) becomes the preceding increment of the additional discriminator (layer 2). All input patterns I (i.e., the combination of the original input pattern features f₁-f₃ and the new features f₄) are then preferably learned with the new increment. The learnable parameters θ² of the new increment serve to encode the residual information necessary to learn the new feature f₄ in the augmented input patterns I.

The mathematical details of this case's incrementation procedure are the same as described earlier with a few alterations. More specifically, the following equation accounts for the addition of new features to the feature vector. If the new input pattern features:

$$I = [ \begin{matrix}{I}^{N - 1} \\ {I}^{N}\end{matrix} ] s . t . \vert I \vert = \vert {I}^{N - 1} \vert + \vert {I}^{N} \vert$$

where the new input pattern I includes features I_{N}, whereas the features of the previous increment's features are denoted I_{N-1}.

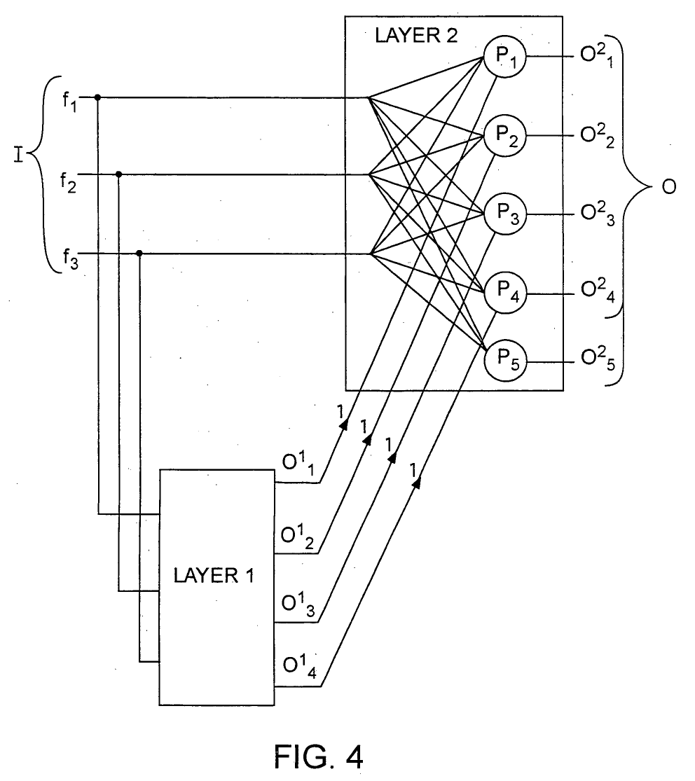

FIG. 6 is a flowchart of a method 600 according to one embodiment. The method 600 begins by operating (610) an original classifier and testing (620) whether it should be augmented. The reasons for augmented the original classifier have been discussed earlier. They include, for example, the original classifier has become stuck on a local maximum; new input patterns; new features from the input patterns; new classes; and a general need to increase the complexity of the classifier. When the decision to augment is made, the method 600 connects (630) an additional discriminator to the one in the original classifier. The method 600 next sets (640) inter-discriminator weights to unity. Those are the weights associated with the connections from the original classifier to the additional classifier. The additional discriminator is a parameterized one, and the method 600 initializes (650) the parameters of the additional discrimination to be zero. Thereafter, the method 600 trains the additional discriminator by repeatedly applying (660) training input patterns for an epoch and adjusting (670) the parameters of the additional discriminator using an RDL algorithm. Preferably, the adjustments are made in a batch mode, such that adjustments are calculated after each input pattern, stored until all input patterns in the learning sample are processed, and then averaged to yield a set of adjustments that are applied to the discriminator. Alternatively, actual change to the discriminator can be made after each input pattern, but that approach tends to be more computationally demanding, less stable, and less likely to converge to a global maximum. After the adjusting step 670, the method 600 determines whether another learning epoch is necessary. If not, the method 600 operates (690) the augmented classifier (featuring both the original discriminator and the additional discriminator connected as successive stages) as if it were the original classifier for purposes of iterating the method 600 to add additional increments.

Note that the operating step 610 and 690 are optional, as the classifier may be simply trained without post-training use. Also, note that the method 600 may be iterated just a single time. Finally, note that the original classifier may or may not be a trainable one; in fact, it need not even be parameterized. If trainable, the original classifier need not be an RDL-trained classifier. In other words, the augmentation of any original classifier is possible with RDL learning applied to the additional discriminator added as a result of the augmentation.

C. Classification Using an Incrementally Trained Classifier

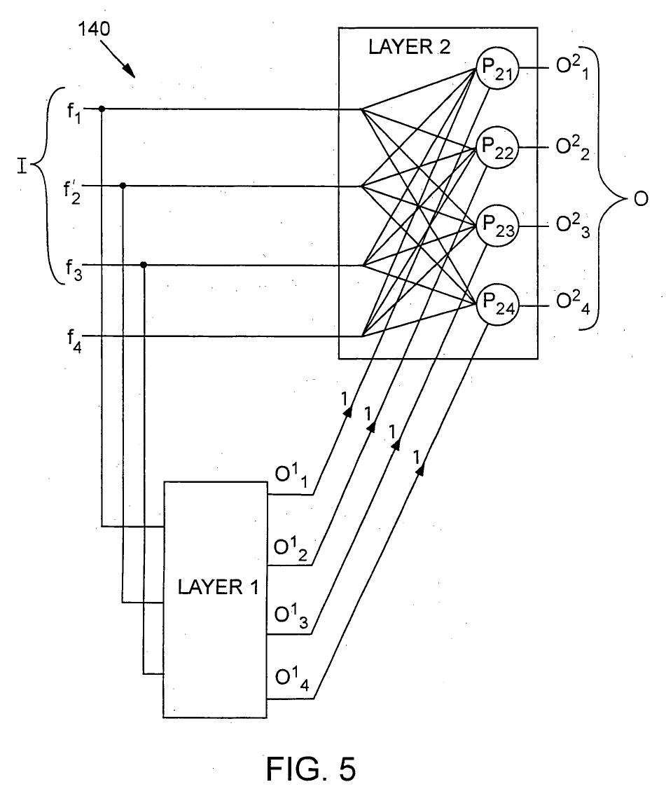

FIG. 7 shows a discriminator 140 with multiple increments. If a scenario's computational and memory budget permit, then all increments are operated and the final outputs are taken from the Nth stage, as shown. Alternatively, a partial classification or value assessment of the input pattern can be made if real-time constraints limit the number of model increments that can be evaluated in the allotted time. Each of the N model increments is, itself in combination with all of its predecessor increments, a valid classifier or value assessment model for the task. The higher the increment, the more correct the classification or valuable the decision assessment is likely to be. But if time is limited, the discriminator 140 can be operated by evaluating its increments in succession until time runs out. In the preferred implementation, the number of increments evaluated in the allotted time is guaranteed to yield the most correct classification from the overall classification model under the imposed evaluation time constraint.

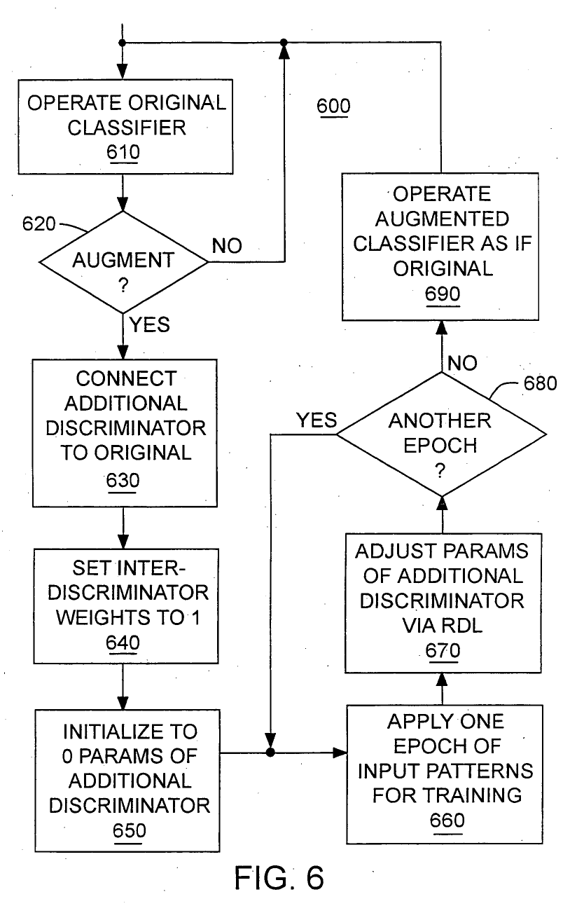

FIG. 8 illustrates the discriminator 140 specifically arranged for classification of input patterns I, which, in this example, are digital images of birds. In the illustrated example, the birds belong to one of six possible species, viz., wren, chickadee, nuthatch, dove, robbin and catbird. Given an input pattern I, the discriminator 140 generates six different output values O, respectively proportional to the likelihood that the input pattern image I is a picture of each of the six possible bird species. If, for example, the value of o₃ is larger than the value of any of the other outputs, the input pattern I is classified as a nuthatch.

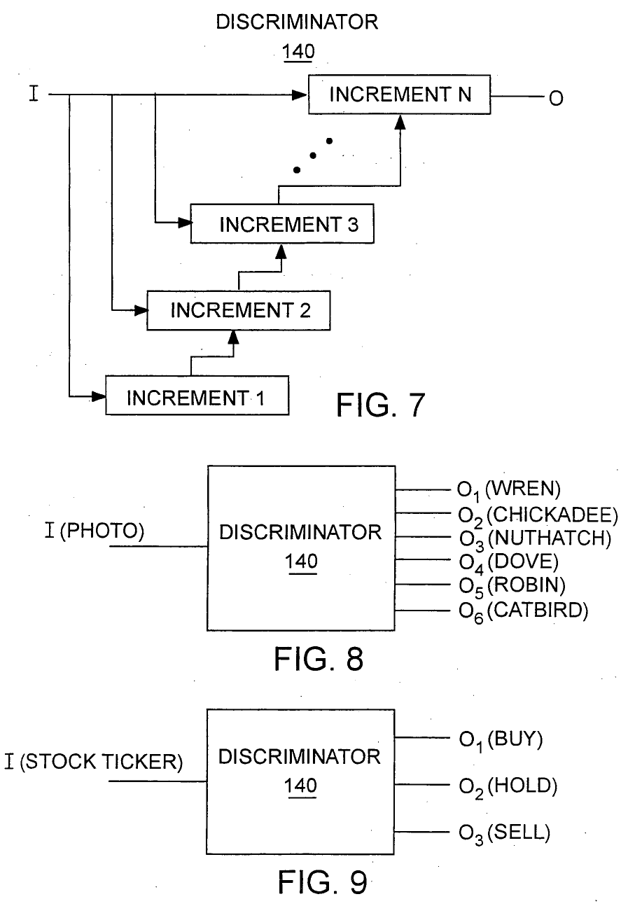

FIG. 9 illustrates the discriminator 140 configured for value assessment of input patterns I, which, are stock ticker data. Given an stock ticker data input pattern I, the discriminator 140 generates three output values O which are, respectively, proportional to the profit or loss that would be incurred if each of three different respective decisions associated with the outputs (e.g., “buy,” “hold,” or “sell”) were taken. If, for example, the hold output (o₃) were larger than any of the other outputs, then the most profitable decision for the particular stock ticker symbol would be to sell that investment.

The algorithms for operating the methods and systems illustrated and described herein can exist in a variety of forms both active and inactive. For example, they can exist as one or more software programs comprised of program instructions in source code, object code, executable code or other formats. Any of the above can be embodied on a computer-readable medium, which include storage devices and signals, in compressed or uncompressed form. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes. Exemplary computer-readable signals, whether modulated using a carrier or not, are signals that a computer system hosting or running a computer program can be configured to access, including signals downloaded through the Internet or other networks. Concrete examples of the foregoing include distribution of software on a CD ROM or via Internet download. In a sense, the Internet itself, as an abstract entity, is a computer-readable medium. The same is true of computer networks in general.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims, and their equivalents, in which all terms are to be understood in their broadest reasonable sense unless otherwise indicated. For example, the term “connecting” connotes direct as well as indirect connections plus all manner of operative connections.

1. A method for augmenting an original discriminator in a classifier, the original discriminator having a set of input connections to receive feature data derived from an input pattern, the original discriminator generating in response to an input pattern a set of original discriminator outputs, the method comprising:
connecting an additional discriminator to the original discriminator, the additional discriminator having a set of parameters, the additional discriminator having a first set of input connections configured to receive feature data derived from an input pattern and a second set of input connections to receive some or all of the set of original discriminator outputs, the additional discriminator generating a set of outputs in response to said some or all of the set of original discriminator outputs and in response to the feature data according to the set of parameters;
applying a set of training input patterns to both the original and additional discriminator in parallel; and
responsive to the training input patterns, adjusting the values of the parameters in the set of parameters using an RDL technique, whereby the combination of the original discriminator and the additional discriminator provides greater classification performance than the original discriminator alone.

2. The method of claim 1, wherein the original discriminator comprises one or more individual discriminators interconnected to each other.

3. The method of claim 2, wherein the individual discriminators are serially connected such that a given individual discriminator has a set of input connections to receive a set of outputs generated by another of the individual discriminators.

4. The method of claim 2, wherein each of the individual discriminators has been incrementally added to the original discriminator and individually trained.

5. The method of claim 1, further comprising:
connecting an second additional discriminator to the combination of the original discriminator and the additional discriminator, the second additional discriminator having a set of second parameters, the second additional discriminator having a first set of input connections to receive feature data derived from the input pattern and a second set of input connections to receive some or all of a set of discriminator outputs generated by the additional discriminator, the second additional discriminator generating a set of second additional outputs in response to said some or all of the set of outputs generated by the additional discriminator and in response to the feature data according to the second set of parameters;
applying a set of second training input patterns to both the combination of the original and additional discriminators as well as to the second additional discriminator; and
responsive to the second training input patterns, adjusting the values of the parameters in the second set of parameters using an RDL technique.

6. The method of claim 1, wherein the original discriminator is a neural network.

7. The method of claim 1, wherein the additional discriminator is a neural network.

8. The method of claim 7, wherein the first set of input connections are synapses, and the set of parameters are synaptic weights corresponding to the synapses.

9. The method of claim 7, wherein the second set of input connections are synapses having unity synaptic weights.

10. The method of claim 1, wherein the original discriminator is a trainable network having been trained by a set of training input patterns.

11. The method of claim 1, wherein the set of training input patterns is the same as a set of training input patterns having been used to train the original classifier.

12. The method of claim 10, wherein the set of training input patterns contains feature data not present in the set of training input patterns used to train the original discriminator.

13. The method of claim 10, wherein the connecting step is performed when the original discriminator has been trained to a point where it has reached a local optimum condition.

14. The method of claim 10, wherein the connecting step is performed when the original discriminator has completed a predetermined number of training epochs.

15. The method of claim 10, wherein the set of original discriminator outputs corresponds to a set of possible output classifications of an input pattern, each of the set of original discriminator outputs being related to a likelihood that the input pattern belongs to a corresponding class in the set of possible output classifications.

16. The method of claim 15, wherein the set of outputs generated by the additional discriminator corresponds to a set of possible output classifications of an input pattern, and wherein the set of outputs generated by the additional discriminator is a proper superset of the set of original discriminator outputs.

17. The method of claim 1, wherein the applying step comprises sequentially applying each input pattern in the set of training input patterns to both the original and additional classifier.

18. The method of claim 17, wherein the adjusting step comprises:
after each sequential application of a training input pattern, calculating adjusted values of the parameters;
after all of the training input patterns have been applied, averaging corresponding adjusted values of the parameters so as to result in a set of averaged adjusted parameter values; and
setting the values of the parameters equal to the averaged adjusted parameter values.

19. The method of claim 17, wherein the adjusting step comprises:
after each sequential application of a training input pattern, calculating adjusted values of the parameters in the set of parameters and setting the values of the parameters equal to the adjusted parameter values.

20. The method of claim 1, wherein the adjusting step comprises:
calculating a risk differential on the basis of the discriminator outputs generated by the additional classifier;
using the risk differential as an input to an RDL objective function; and
maximizing the RDL objective function with respect to the set of parameters.

21. The method of claim 20, wherein the maximizing step comprises:
performing a gradient ascent algorithm.

22. The method of claim 21, wherein the gradient ascent algorithm is a gradient ascent algorithm with momentum and weight decay when the number of outputs generated by the additional discriminator is at least four.

23. The method of claim 21, wherein the gradient ascent algorithm is a conjugate gradient ascent algorithm when the number of outputs generated by the additional discriminator is three or less.

24. The method of claim 1, wherein the input patterns are object images, and the classifier performs object classification.

25. The method of claim 1, wherein each of the set of outputs generated by the additional discriminator represents a value, and the method further comprises:
picking the maximum output from the set of outputs generated by the additional discriminator, thereby performing a value assessment task.

26. The method of claim 25, wherein the set of outputs generated by the additional discriminator consists essentially of outputs corresponding to buy, sell, and hold.

27. The method of claim 1, wherein the adjusting step comprises:
initializing values of the parameters to be zero.

28. The method of claim 1, further comprising:
picking a class corresponding to the maximum output generated by the additional discriminator as an estimated classification of the input pattern.

29. A classifier augmented according to the method of claim 1.

30. A computer-readable medium embodying computer software instructions performing the method of claim 1.

31. A system for augmenting an original classifier, the original classifier having a set of input connections to receive feature data derived from an input pattern, the original classifier generating in response to an input pattern a set of original discriminator outputs, the system comprising:
a means for connecting an additional classifier to the original classifier, the additional classifier having a set of parameters, the additional classifier having a first set of input connections to receive feature data derived from an input pattern and a second set of input connections to receive some or all of the set of original discriminator outputs, the additional classifier generating a set of discriminator outputs in response to said some or all of the set of original discriminator outputs and in response to the feature data according to the set of parameters;
a means for generating a set of training input patterns and respective actual classifications of the training input patterns;
a means for applying the set of training input patterns to both the original and additional classifiers in parallel;
a means for adjusting the values of the parameters in the set of parameters using an RDL technique responsive to the training input patterns, whereby the combination of the original classifier and the additional classifier provides greater classification performance than the original classifier alone; and
a means for generating a classification estimate that is the maximum of the discriminator outputs of the additional classifier.

32. A system comprising:
a data source generating input patterns and respective actual classifications of the input patterns;
a classifier comprising a discriminator comprising N layers interconnected in an ordered arrangement from layer 1 to layer N, each layer having a set of inputs connected to the data source via a parameterized model, each layer generating a set of outputs that are related to likelihoods that an input pattern belongs to a respective class in a set of possible classes, each layer but layer 1 having a set of inputs connected to the outputs of a previous layer; and
a RDL module having inputs connected to the outputs of layer i of the discriminator, wherein the data source, the discriminator, and the RDL module cooperate to successively train the i-th layer of the discriminator while holding constant all parameters of layers 1 though i−1 and without activating any layer i+1 through N, as i ranges from 1 to N.

33. The system of claim 32, further comprising:
a final output stage having a set of inputs connected to the outputs of layer N. of the classifier, the final output stage generating an output that corresponds to the maximum of its inputs.

34. The system of claim 32, wherein the RDL module comprises:
a risk differential calculator having a set of inputs connected to the outputs of layer i of the classification system and an input connected to receive the actual classification from the data source, the risk differential calculator computing a difference between its input corresponding to the actual classification and the largest of the other of its inputs;
an RDL objective function having a risk differential argument, the value of which is determined by the risk differential calculator;
a maximization algorithm applied to the objective function with respect to the synaptic weight parameters of layer i of the classification system.

35. The system of claim 34, wherein the maximization algorithm is a gradient ascent algorithm.

36. The system of claim 32, wherein the classifier is a multi-layer neural network.

37. The system of claim 36, wherein the set of inputs connecting each layer but layer 1 to the outputs of a previous layer are synapses having fixed unity weights.

38. The system of claim 36, wherein the parameterized model has synaptic weight parameters.

39. A method for building a multi-layered classifier capable of accepting an input pattern and generating an output that indicates a class to which the input pattern is likely associated out of a set of possible classes, the classifier being built by successively adding new layers to the system so as to result in the classifier comprising an ordered set of N interconnected layers, wherein N≧2, each layer characterized by a set of parameters, the method comprising:
adjusting the parameters of a first layer using a first set of input patterns, the adjusting step being based a first RDL objective function;
holding the parameters of the first layer constant after the step of adjusting the parameters of the first layer;
adding a second layer to the classification system; and
adjusting the parameters of the second layer using a second set of input patterns, the adjusting step being based on a second RDL objective function.

40. The method of claim 39, wherein the classifier is a neural network.

41. The method of claim 39, wherein the first set of input patterns and the second set of input patterns are the same.

42. The method of claim 39, wherein the first RDL objective function and the second RDL objective function are the same.

43. The method of claim 39, wherein for each input pattern the first layer produces an output classification from a first set of possible output classifications, for each input pattem the second layer produces an output classification from a second set of possible output classifications, and the first set of possible output classifications and the second set of possible output classifications are the same.

44. The method of claim 39, wherein the ordered series of N interconnected layers are serially connected such that outputs of one layer are inputs to the next subsequent layer.

45. The method of claim 39, wherein the step of adjusting the parameters of the first layer using the first set of input patterns comprises:
feeding one of the first set of input patterns to the first layer;
generating by the first layer in response to the feeding step a set of outputs related to the probability that the fed input pattern belongs to a respective class of the first set of possible classes;
calculating adjusted parameters of the first layer based on the outputs and a reference classification of the fed input pattern;
repeating the feeding, generating, and calculating steps for each of the input patterns in the first set of input patterns;
after the repeating step, averaging the results of each calculating step so as to result in a set of average adjusted parameters of the first layer; and
overwriting the first set of parameters in the first layer with the set of average adjusted parameters of the first layer.

46. The method of claim 39, wherein the step of adjusting the parameters of the second layer using the first set of input patterns comprises:
feeding one of the first set of input patterns to both the first layer and the second layer;
generating by the first layer in response to the feeding step a set of outputs related to the probability that the fed input pattern belongs to a respective class of the first set of possible classes;
generating by the second layer in response to the feeding step a set of outputs related to the probability that the fed input pattern belongs to a respective class of the second set of possible classes;
calculating adjusted parameters of the second layer based on the outputs and a reference classification of the fed input pattern;
repeating the feeding, generating, and calculating steps for each of the input patterns in the second set of input patterns;
after the repeating step, averaging the results of each calculating step so as to result in a set of average adjusted parameters of the second layer; and
overwriting the first set of parameters in the second layer with the set of average adjusted parameters of the second layer.

47. The method of claim 39, further comprising:
repeating the holding, adding, and adjusting steps for third and subsequent layers of the classification system, wherein the holding step holds parameters of each preceding layer constant, the adding step adds an additional layer, and the adjusting step adjusts the parameters of the additional layer.

48. The method of claim 39, wherein each adjusting step comprises:
calculating a risk differential on the basis of the outputs of the classification system and an actual classification of an input pattern;
using the risk differential as an input to the RDL objective function; and
maximizing the RDL objective function with respect to the parameters of the last layer added to the classification system.
